(19) United States
(12) Patent Application Publication
(10) Pub. No.: US 2025/0199803 A1
(43) Pub. Date: Jun. 19, 2025

(54) NON-TRANSITORY COMPUTER-READABLE RECORDING MEDIUM STORING COMPUTER PROGRAM FOR TERMINAL DEVICE, TERMINAL DEVICE, AND METHOD FOR CONTROLLING TERMINAL DEVICE

(71) Applicant: BROTHER KOGYO KABUSHIKI KAISHA, NAGOYA (JP)

(72) Inventor: Megumi HATA, Nagakute (JP)

(21) Appl. No.: 18/979,858

(22) Filed: Dec. 13, 2024

(30) Foreign Application Priority Data
Dec. 19, 2023 (JP) 2023-214086

(51) Int. Cl. G06F 8/71

(52) U.S. Cl. CPC G06F 8/71

(57) ABSTRACT

A terminal device may, in a case where a first operation is received, determine whether a version of a computer program is a first version or newer. The terminal device may, in a case where it is determined that the version of the computer program is not the first version or newer, display on a display of the terminal device a first notification screen for prompting a user to upgrade the computer program. The terminal device may, in a case where an operation to upgrade the computer program is not received in the first notification screen, restrict the user from using the first function via the terminal device.

### REFERENCE TO RELATED APPLICATION

This application claims priority to Japanese Patent Application No. 2023-214086 filed on Dec. 19, 2023. The entire content of the priority application is incorporated herein by reference.

### BACKGROUND ART

A communication system including a plurality of MFPs, a terminal device, a notification server, a service providing server, and a service management server is known. The terminal device receives notification information from the notification server. The terminal device displays a notification screen in response to a filter condition and a timing condition being satisfied.

### SUMMARY

The technology above does not give any consideration to upgrading a version of a computer program for the terminal device.

The disclosure herein provides a technology for displaying a first notification screen at an appropriate time to prompt a user to update the version of a computer program.

The disclosure herein provides a non-transitory computer-readable recording medium storing a computer program for a terminal device comprising a processor. The computer program, when executed by the processor, may cause the terminal device to: in a case where a first operation is received, determine whether a version of the computer program is a first version or newer, wherein the first operation is for using a first function realized by cooperation between a target device different from the terminal device and a first service providing server that provides a first service related to the target device; in a case where it is determined that the version of the computer program is not the first version or newer, display on a display of the terminal device a first notification screen for prompting a user to upgrade the computer program; and in a case where an operation to upgrade the computer program is not received in the first notification screen, restrict the user from using the first function via the terminal device.

According to the configuration above, the terminal device displays the first notification screen in the case where the first operation is received and the version of the computer program is determined as not being the first version or newer. Thus, the terminal device can display the first notification screen at an appropriate time. This improves user convenience.

The terminal device implemented by the above computer program and a method for controlling the terminal device are also novel and useful. Further, a communication system comprising the terminal device, the target device, and the first service providing server is also novel and useful. The computer program includes one or more programs.

### BRIEF DESCRIPTION OF DRAWINGS

FIG. 1 shows a configuration of a communication system.

FIG. 2 shows exemplary tables.

FIG. 3 shows exemplary screens displayed at a terminal device during a device registration process.

FIG. 4 shows a flowchart of a first check process executed by the terminal device.

FIG. 5 shows a flowchart of a function execution process executed by the terminal device.

FIG. 6 shows an example of first application notification screen displayed at the terminal device.

FIG. 7 shows an example of first application notification screen displayed at the terminal device.

FIG. 8 shows an example of service screen displayed at the terminal device.

FIG. 9 shows a flowchart of a function execution process according to a second embodiment.

FIG. 10 shows a flowchart of a second function execution process according to the second embodiment.

FIG. 11 shows an example of second application notification screen displayed at the terminal device.

FIG. 12 shows an example of service screen displayed at the terminal device.

FIG. 13 shows an example of service screen displayed at the terminal device.

FIG. 14 shows an example of service screen displayed at the terminal device.

### DESCRIPTION

### First Embodiment

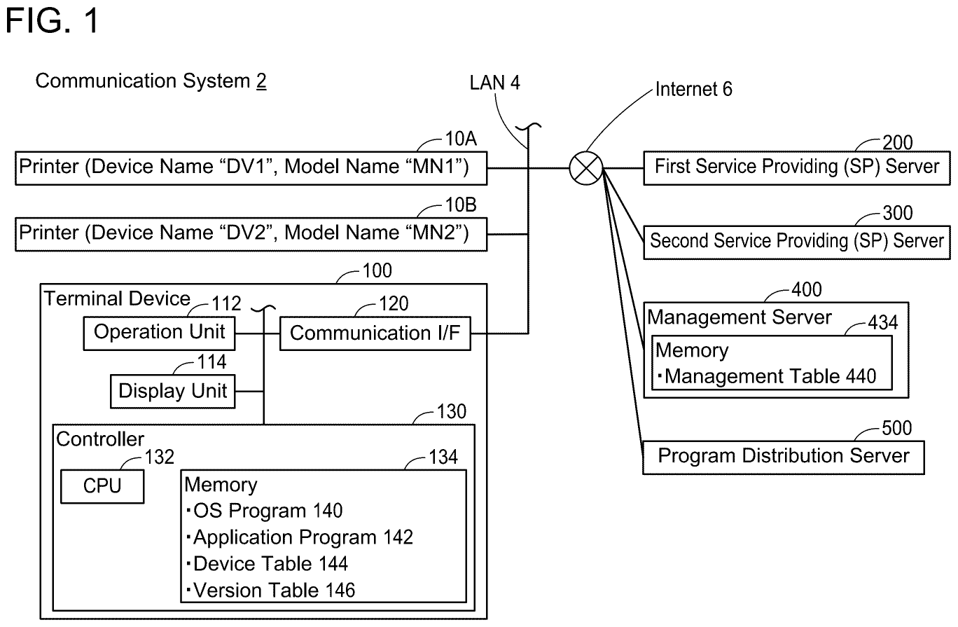

### (Configuration of Communication System 2; FIG. 1)

As shown in FIG. 1, a communication system 2 comprises a plurality of printers 10A, 10B, a terminal device 100, a first service providing server 200, a second service providing server 300, a management server 400, and a program distribution server 500. Hereinafter, a service providing server is abbreviated as “SP server”. The printers 10A, 10B and the terminal device 100 are connected to a local area network (LAN) 4. The printers 10A, 10B and the terminal device 100 are communicable with each other via the LAN 4. The printers 10A, 10B, the terminal device 100, the first SP server 200, the second SP server 300, the management server 400, and the program distribution server 500 are connected to the internet 6. The printers 10A, 10B, the terminal device 100, the first SP server 200, the second SP server 300, the management server 400, and the program distribution server 500 are communicable with each other via the internet 6.

### (Configurations of Printers 10A, 10B)

The printers 10A, 10B are peripheral devices (i.e., peripheral devices of a PC, etc.) configured to execute a print function. In a modification, the printers 10A, 10B may be multifunctional devices configured to execute a scan function, facsimile function, a copy function, etc. in addition to the print function. The printer 10A has a device name “DV1” and a model name “MN1”. The printer 10B has a device name “DV2” and a model name “MN2”. The device names are assigned to the printers 10A, 10B by administrators of the printers. The model names indicate models of the printers.

The printers 10A, 10B may include a print engine of inkjet scheme, electrophotographic scheme or thermal scheme. The print engine of inkjet scheme includes a print head that ejects ink droplets. The print engine of electrophotographic scheme includes a photoreceptor and an exposure device that exposes the photoreceptor by emitting light. The print engine of thermal scheme includes a print head that emits heat with a heater.

### (Configuration of Terminal Device 100)

The terminal device 100 is a terminal device such as a mobile phone (e.g., a smart phone), a PDA, a desktop PC, a laptop PC, a tablet PC, or the like. The terminal device 100 comprises an operation unit 112, a display unit 114, a communication interface 120, and a controller 130. Hereinafter, an interface is abbreviated as “I/F”.

The operation unit 112 is a user interface through which a user can input various information to the terminal device 100. The operation unit 112 comprises for example a touch screen for displaying software keys (operation objects), hardware keys, or both of these. The hardware keys comprise for example buttons, switches, or the like. The display unit 114 is a display or a panel configured to display various information. The panel may or may not be a touch panel. The panel is for example a liquid crystal panel or an organic EL panel. The communication I/F 120 is connected to the LAN 4.

The controller 130 comprises a CPU 132 and a memory 134. The memory 134 comprises a main storage and an auxiliary storage. In an example, the main storage comprises a RAM and a cache memory. In an example, the auxiliary storage comprises a ROM, a flash memory, a solid state drive (SSD), a hard disk drive (HDD), or a combination of these. An OS program 140 and an application program 142 are stored in the auxiliary storage of the memory 134. Hereinafter, the OS program 140 and the application program 142 are termed “OS 140” and “app 142”, respectively. The OS 140 controls the basic operation of the terminal device 100. In an example, the app 142 causes a printer to execute its print function. The CPU 132 implements various processes according to programs loaded from the auxiliary storage to the main storage. Hereinafter, the various processes implemented by the CPU 132 according to the programs may be described as if the OS 140 or the app 142 executes the processes. A device table 144 and a version table 146 are also stored in the auxiliary storage of the memory 134.

### (Configuration of First SP Server 200)

The first SP server 200 is established on the internet 6 by a vendor of the printers 10A, 10B (simply termed “the vendor” hereinafter). The first SP server 200 may be a single server or a collectivity of multiple servers. The first SP server 200 provides a subscription service related to the printers. The subscription service is a flat-rate service that charges a flat fee if the number of printed sheets within a predetermined period (e.g., a month) is equal to or less than the contractual number of sheets (e.g., 1000 sheets), and if the number of printed sheets within the predetermined period exceeds the contractual number of sheets, charges the total amount of the flat fee and an amount for the exceeded sheets. The subscription service may include an automatic ordering service that automatically orders a new cartridge when the remaining amount of ink in the cartridge mounted in a printer becomes less than a predetermined amount. The user can use a subscription service function associated with the subscription service, via the terminal device 100. The subscription service function is realized by cooperation between a printer and the first SP server 200. The subscription service function comprises a function for subscribing to the subscription service, a function for changing a setting related to the subscription service, etc.

### (Configuration of Second SP Server 300)

The second SP server 300 is established on the internet 6 by the vendor. The second SP server 300 may be a single server or a collectivity of multiple servers. The second SP server 300 provides a remote print service related to printers. The remote print service allows a user to send a print instruction to a printer via the second SP server 300 when the user is away from home/office. The user can use a remote print service function associated with the remote print service, via the terminal device 100. The remote print service function is realized by cooperation between a printer and the second SP server 300. The remote print service function comprises a function for subscribing to the remote print service, a function for changing a setting related to the remote print service, etc.

### (Configuration of Management Server 400)

The management server 400 is established on the internet 6 by the vendor. The management server 400 may be a single server or a collectivity of multiple servers. The management server 400 manages versions of programs for the subscription service and the remote print service. A management table 440 is stored in a memory 434 of the management server 400.

### (Configuration of Program Distribution Server 500)

The program distribution server 500 is established on the internet 6 by the vendor. In a modification, the program distribution server 500 may be established on the internet 6 by a business operator different from the vendor. The program distribution server 500 may be a signal server or a collectivity of multiple servers. The program distribution server 500 manages application programs for terminal devices and firmware for printers. The firmware is a program for implementing specific operations of a printer (e.g., operation of its print execution unit, etc.).

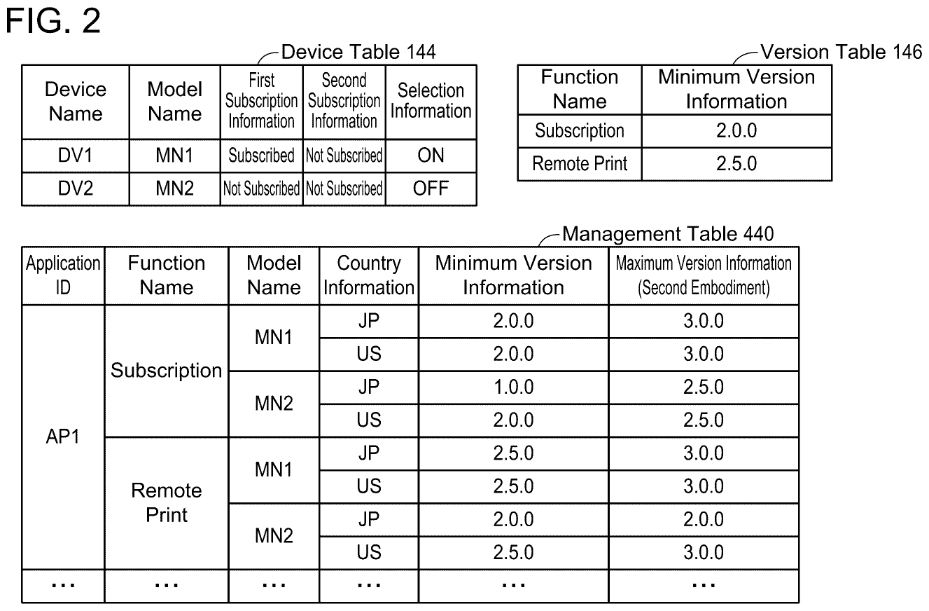

### (Contents of Tables: FIG. 2)

Referring to FIG. 2, contents of the device table 144 and the version table 146 in the terminal device 100 and the contents of the management table 440 in the management server 400 are described.

The device table 144 in the terminal device 100 is for management of information related to devices registered in the app 142. In the device table 144, device names, model names, first subscription information, second subscription information, and selection information are stored in association with each other. Each first subscription information selectively indicates either “Subscribed”, which indicates that a printer having the device name associated with the first subscription information has already subscribed to the subscription service, or “Not Subscribed”, which indicates that the device has not subscribed to the subscription service yet. Each second subscription information selectively indicates either “Subscribed”, which indicates that a printer having the device name associated with the second subscription information has already subscribed to the remote print service, or “Not Subscribed”, which indicates that the device has not subscribed to the remote print service yet. The selection information selectively indicates either “ON”, which indicates that the device associated with this selection information is a destination of instruction information, or “OFF”, which indicates that the device is not a destination of instruction information. The instruction information comprises a print instruction, etc.

The version table 146 in the terminal device 100 is for management of minimum version information. In the version table 146, function names and minimum version information are stored in association with each other. For example, the function names are “subscription” indicating the subscription service function and “remote print” indicating the remote print service function. Each minimum version information indicates a minimum version required to use the service function associated with this minimum version information.

The management table 440 in the management server 400 is for management of minimum version information. In the management table 440, app IDs, function names, model names, country information, and minimum version information are associated with each other. The app IDs are information for identifying application programs including mobile application programs and PC application programs. The information in the management table 440 is set by the administrator of the management server 400. According to the configuration above, the minimum version information can be managed by app ID, by function name, by model name, and by country information.

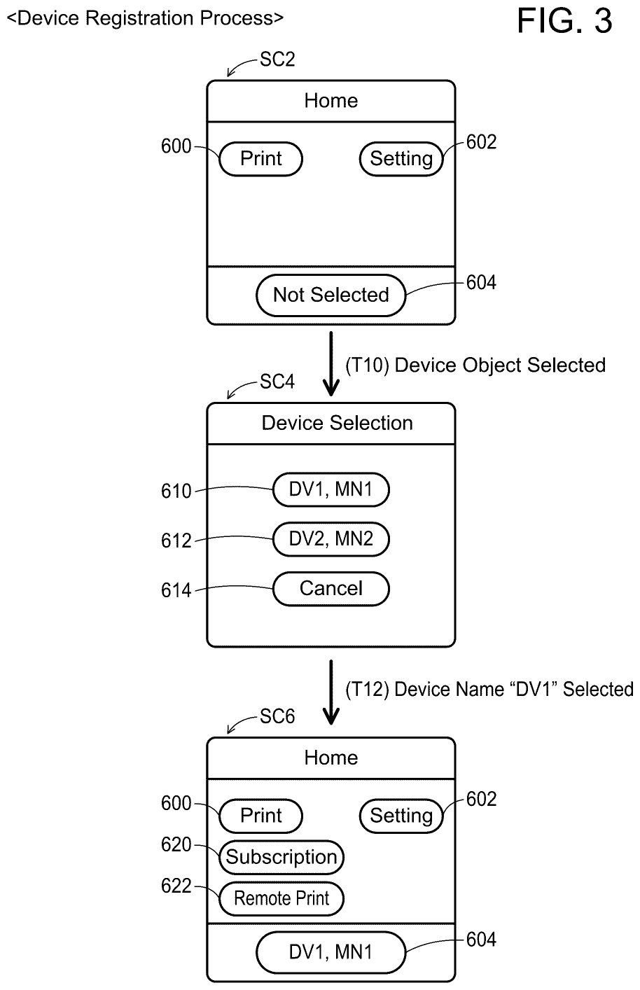

### (Registration Process: FIG. 3)

Referring to FIG. 3, a device registration process for registering a device in the app 142 is described. Hereinafter, all communications between the terminal device 100 and the other devices (the printers 10A, 10B, the servers 200, 300, 400, 500) are via the communication I/F 120 of the terminal device 100. Thus, a phrase “via the communication I/F 120” is omitted hereinafter. Further, the app 142 accesses hardware such as the display unit 114, the memory 134, and the communication I/F 120 via the OS 140 to execute various processes. Hereinafter, the app 142 executing a process via the OS 140 may be omitted.

First, the user of the terminal device 100 performs an operation for activating the app 142 on the terminal device 100. In response, the app 142 in the terminal device 100 displays a home screen SC2 on the display unit 114. The home screen SC2 includes a print button 600, a setting button 602, and a device object 604. The device object 604 shows information related to a device that is a destination of instruction information. If two or more devices have already been registered in the app 142, the device object 604 shows information related to one of the two or more devices. Specifically, the device object 604 shows a device name and a model name associated with the selection information “ON” in the device table 144 in the terminal device 100. If no devices have been registered yet in the app 142, the device object 604 shows a letter string “Not Selected”.

In T10, the user performs an operation on the device object 604 in the home screen SC2. In response, the app 142 executes a search process to search for devices within the LAN 4 and displays a device selection screen SC4 on the display unit 114. In the search process, the app 142 sends a search signal to the LAN 4 to search for devices within the LAN 4 and then receives, in response to the sending of the search signal, response signals each including a device name and a model name from devices within the LAN 4 (two printers 10A, 10B in this embodiment). The app 142 displays the device selection screen SC4 on the display unit 114 by using the received response signals. The device selection screen SC4 includes device buttons 610, 612 corresponding to the received response signals and a cancel button 614. Each of the device buttons 610, 612 is for selection of a device to be registered in the app 142. The device buttons 610, 612 correspond to the printers 10A, 10B, respectively.

In T12, the user performs an operation on the device button 610 in the device selection screen SC4. In response, the app 142 registers, in the device table 144, the device name “DV1” and the model name “MN1” associated with the device button 610. The app 142 further stores the first subscription information “Not Subscribed”, the second subscription information “Not Subscribed”, and the selection information “ON” in the device table 144. The printer 10A is thus registered in the app 142. Then, the app 142 displays a home screen SC6 on the display unit 114. The home screen SC6 includes a subscription button 620 and a remote print button 622 in addition to the print button 600, the setting button 602, and the device object 604. The subscription button 620 and the remote print button 622 are for using the subscription service function and the remote print service function, respectively. The device object 604 in the home screen SC6 shows the device name “DV1” and the model name “MN1”.

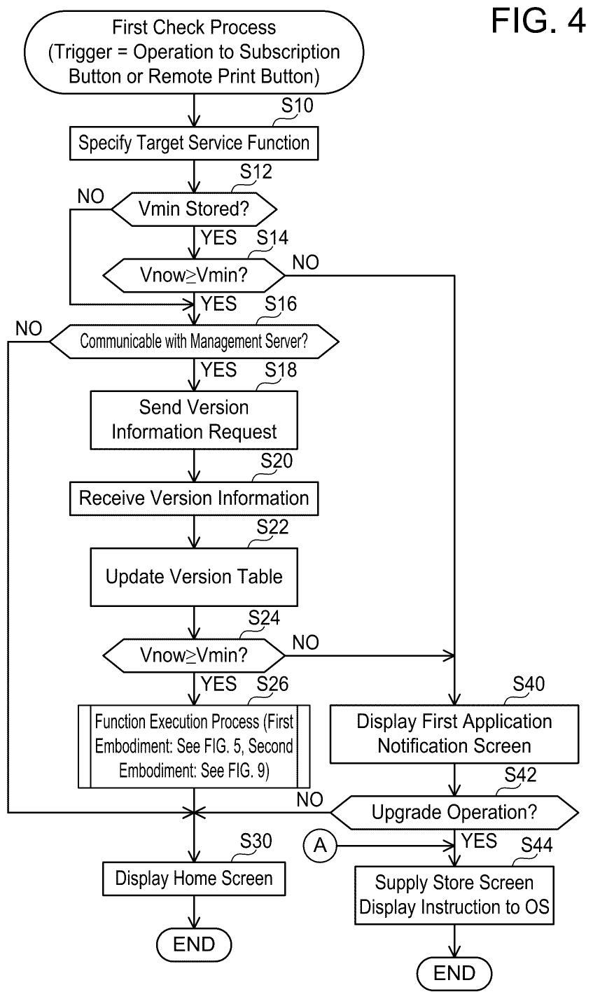

### (First Check Process: FIG. 4)

Referring to FIG. 4, a first check process executed by the app 142 in the terminal device 100 is described. The app 142 starts the process of FIG. 4 in response to receiving an operation on the remote print button or the subscription button in the home screen.

In S10, the app 142 specifies a target service function. In response to receiving the operation on the subscription button, the app 142 specifies the subscription service function as the target service function, whereas in response to receiving the operation on the remote print button, the app 142 specifies the remote print service function as the target service function.

In S12, the app 142 determines whether minimum version information indicating a minimum version Vmin corresponding to the target service function is in the version table 146. When determining that the minimum version information is in the version table 146 (YES in S12), the app 142 proceeds to S14, whereas when determining that the minimum version information is not in the version table 146 (NO in S12), the app 142 skips S14 and proceeds to S16.

In S14, the app 142 determines whether a current version Vnow of the app 142 is the minimum version Vmin corresponding to the target service function or newer. Current version information indicating the current version Vnow is stored in the memory 134. When determining that the current version Vnow is the minimum version Vmin or newer (YES in S14), the app 142 proceeds to S16, whereas when determining that the current version Vnow is not the minimum version Vmin or newer (NO in S14), the app 142 proceeds to S40. The current version Vnow not being the minimum version Vmin or newer means that the app 142 is not compliant with the target service function and thus the user cannot use the target service function via the terminal device 100. In an example, the app 142 not being compliant with the target service function may include that the app 142 is not compliant with a protocol for using the target service function.

In S16, the app 142 determines whether the terminal device 100 is communicable with the management server 400. For example, the app 142 sends a PING signal to the management server 400. In this case, the app 142 determines whether the terminal device 100 is communicable with the management server 400 based on whether the app 142 receives from the management server 400 a response signal to the PING signal. When determining that the terminal device 100 is communicable with the management server 400 (YES in S16), the app 142 proceeds to S18, whereas when determining that the terminal device 100 is not communicable with the management server 400 (NO in S16), the app 142 proceeds to S30. The terminal device 100 not being communicable with the management server 400 means, for example, that the management server 400 is down, that the management server 400 is under maintenance, that a communication malfunction occurs on the internet 6, or that a communication malfunction occurs between the LAN 4 and the internet 6. In a modification, when making the determination No in S16, the app 142 may display on the display unit 114 an error notification screen indicating that the terminal device 100 is not communicable with the management server 400, and then proceed to S30.

In S18, the app 142 sends a version information request to the management server 400. The version information request is a signal that requests the management server 400 to send version information corresponding to the target service function. The version information request includes an app ID “AP1” of the app 142, a function name, a model name, and country information. The function name is the function name of the target service (e.g., “subscription”, “remote print”). The model name is a model name of a printer associated with the selection information “ON” in the device table 144 (this printer is termed “target printer” hereinafter). The country information indicates a country in which the target printer is installed. In response to receiving the version information request from the terminal device 100, the management server 400 specifies minimum version information based on the information in the request and the management table 440. The management server 400 then sends version information including the specified minimum version information to the terminal device 100.

In S20, the app 142 receives the version information from the management server 400. Thus, the app 142 can execute a sequence from S22 using the latest version information.

In S22, the app 142 updates the version table 146 by using the received version information. Specifically, the app 142 stores, in the version table 146, the minimum version Vmin indicated by the minimum version information included in the version information as a minimum version Vmin required to use the target service function.

In S24, the app 142 determines whether the current version Vnow of the app 142 is the minimum version Vmin indicated by the minimum version information included in the received version information or newer. When determining that the current version Vnow is the minimum version Vmin or newer (YES in S24), the app 142 proceeds to S26, whereas when determining that the current version Vnow is not the minimum version Vmin or newer (NO in S24), the app 142 proceeds to S40.

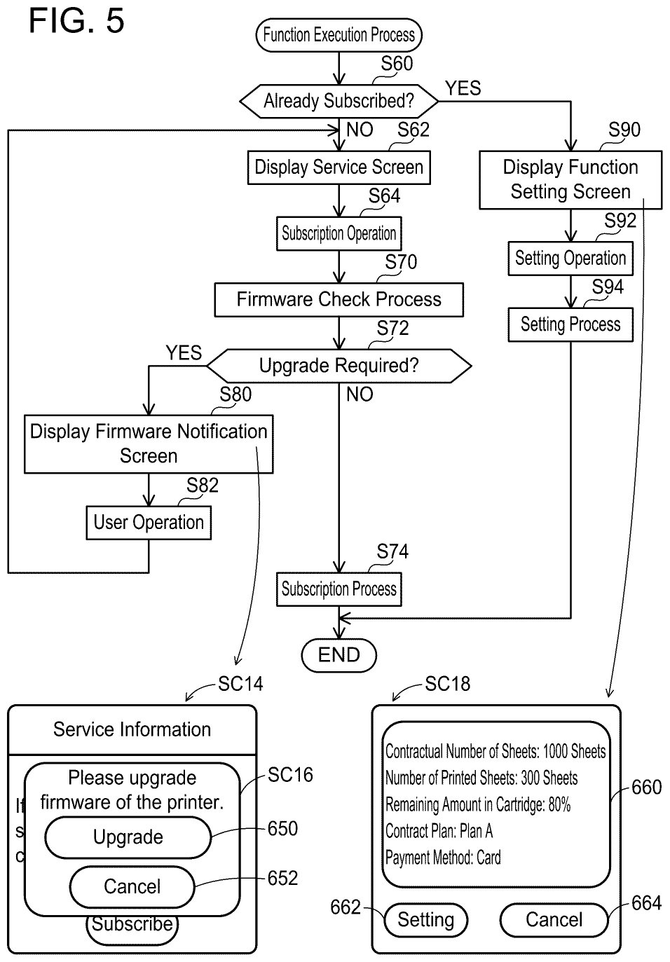

In S26, the app 142 executes a function execution process (see FIG. 5). The function execution process is for the user to use the target service function via the terminal device 100.

In S30, the app 142 displays a home screen on the display unit 114. When S30 is completed, the app 142 terminates the process of FIG. 4.

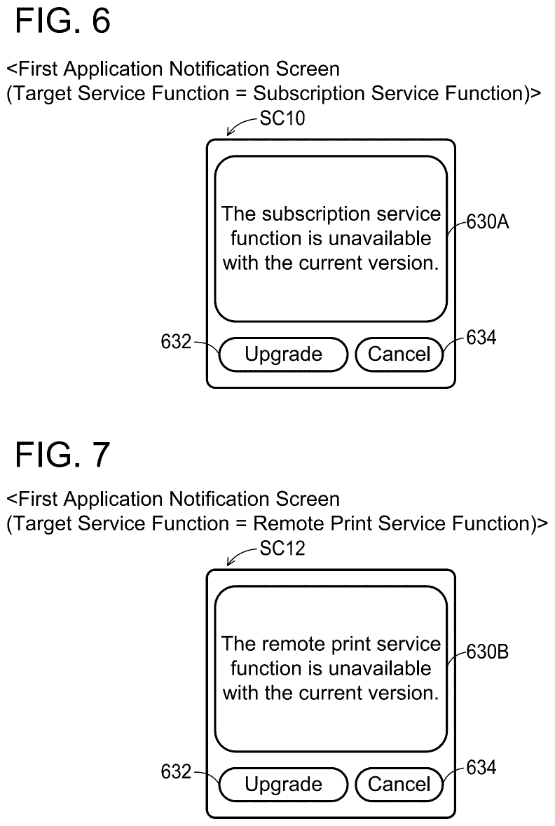

In response to making the determination NO in S14 or the determination NO in S24, the app 142 displays a first app notification screen on the display unit 114 in S40. Referring to FIGS. 6 and 7, the first app notification screen is described. A first app notification screen SC10 shown in FIG. 6 is displayed when the target service function is the subscription service function. The first app notification screen SC10 includes a message 630A, an upgrade button 632, and a cancel button 634. The message 630A comprises a message indicating that the subscription service function is not available with the current version Vnow and a message for prompting the user to upgrade the version of the app 142. The user can upgrade the version of the app 142 by selecting the upgrade button 632. A first app notification screen SC12 shown in FIG. 7 is displayed when the target service function is the remote print service function. The first app notification screen SC12 includes a message 630B, the upgrade button 632, and the cancel button 634. The message 630B comprises a message indicating that the remote print service function is not available with the current version Vnow and a message for prompting the user to upgrade the version of the app 142.

As described, the app 142 does not send a version information request to the management server 400 after making the determination NO in S14 of FIG. 4 based on the minimum version information in the version table 146. Every time minimum version information in the management table 440 in the management server 400 is updated, the minimum version Vmin indicated by the minimum version information becomes newer. That is, the minimum version Vmin indicated by minimum version information in the version table 146 in the terminal device 100 will never be newer than minimum version Vmin indicated by minimum version information in the management table 440. Thus, when the determination NO is made in S14 based on the minimum version information in the version table 146, the current version Vnow is older than the latest minimum version Vmin. The configuration above suppresses an unnecessary process from being executed.

In S42, the app 142 determines whether an upgrade operation of selecting the upgrade button in the first app notification screen has been received. When determining that the upgrade operation has been received (YES in S42), the app 142 proceeds to S44, whereas when determining that the upgrade operation has not been received (NO in S42), the app 142 proceeds to S30. That is, when the upgrade operation is not received, the home screen is displayed on the display unit 114 without the user using the target service function. This can be said that the app 142 restricts the user from using the target service function via the terminal device 100.

As described, the app 142 also restricts the user from using the target service function via the terminal device 100 when determining that the terminal device 100 is not communicable with the management server 400. If the user attempts to use the target service function without the app 142 determining whether the current version Vnow is the minimum version Vmin or newer using the latest version information, an error may occur. This may bother the user. The configuration above suppresses the user from feeling bothered.

In S44, the app 142 supplies a store screen display instruction to the OS 140. The store screen display instruction is a signal that instructs the OS 140 to display a store screen corresponding to the app 142. When S44 is completed, the app 142 terminates the process of FIG. 4. In response to acquiring the store screen display instruction from the app 142, the OS 140 displays the store screen on the display unit 114. Then, in response to receiving an operation for upgrading the version of the app 142, the OS 140 sends a program request to the program distribution server 500 and receives an app with a maximum version Vmax from the program distribution server 500. The OS 140 then upgrades the version of the app 142 in the memory 134 by using the received app with the maximum version Vmax. The version of the app 142 is thereby upgraded to the maximum version Vmax. The app 142 is rebooted when the version of the app 142 is upgraded.

### (Function Execution Process: FIG. 5)

Referring to FIG. 5, the function execution process executed in S26 of FIG. 4 is described.

In S60, the app 142 determines whether the user of the target printer has already subscribed to the service corresponding to the target service function (this service is termed “target service” hereinafter) based on the device table 144. The app 142 specifies, in the device table 144, subscription information that is associated with the device name of the target printer and corresponds to the target service. The app 142 specifies the first subscription information in the device table 144 when the subscription service is the target service, whereas the app 142 specifies the second subscription information in the device table 144 when the remote print service is the target service. When the specified subscription information indicates “Subscribed”, the app 142 makes the determination YES in S60 and proceeds to S90, whereas when the specified subscription information indicates “Not Subscribed”, the app 142 makes the determination NO in S60 and proceeds to S62.

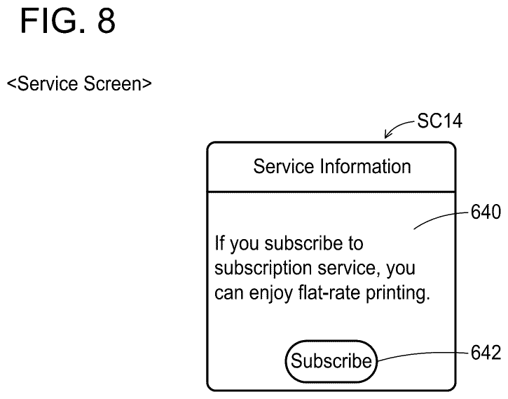

In S62, the app 142 displays a service screen corresponding to the target service on the display unit 114. Here, a service screen to be displayed in case of the subscription service being the target service is described with reference to FIG. 8. The app 142 first sends a screen data request (URL) corresponding to the current version Vnow to the first SP server 200, receives service screen data from the first SP server 200, and then displays on the display unit 114 a service screen SC14 represented by the received service screen data. The service screen SC14 includes a message 640 and a subscribe button 642. The message 640 indicates information of the subscription service. In an example, the message 640 says “If you subscribe to the subscription service, you can enjoy flat-rate printing”. A service screen to be displayed in case of the remote print service being the target service includes a message indicating information of the remote print service instead of the message 640, although this is not shown.

In S64 of FIG. 5, the app 142 receives a subscription operation of selecting the subscribe button in the service screen.

In S70, the app 142 executes a firmware check process to check the version of firmware installed in the target printer. In the firmware check process, the app 142 sends a firmware version information request to the target printer and then receives, from the target printer, firmware version information indicating the version of firmware installed in the target printer. The app 142 determines whether the version indicated by the firmware version information is the maximum version of the firmware. When determining that the version of the firmware is not the maximum version, the app 142 determines that the version of the firmware needs to be upgraded, whereas when determining that the version of the firmware is the maximum version, the app 142 determines that the version of the firmware does not need to be upgraded.

In S72, the app 142 determines whether the version of the firmware has been determined as needing to be upgraded in the firmware check process. When determining that the version of the firmware has not been determined as needing to be upgraded (NO in S72), the app 142 proceeds to S74, whereas when determining that the version of the firmware has been determined as needing to be upgraded (YES in S72), the app 142 proceeds to S80.

In S74, the app 142 executes a subscription process. The subscription process is for subscription to the target service.

In case of the target service being the subscription service, the subscription process is executed between the target printer, the terminal device 100, and the first SP server 200. This subscription process includes a first establishment process, a first device registration process, a payment information registration process, etc. The first establishment process is for establishing an always-on connection between the target printer and the first SP server 200. The always-on connection is for example an Extensible Messaging and Presence Protocol (XMPP) connection. The first device registration process is for registering the device name of the target printer in the first SP server 200. The device name of the target printer is registered in the first SP server 200 by the device name being sent from the target printer to the first SP server 200. The payment information registration process is for registering information for payment of print fees. In the subscription process, a plurality of screen data (web pages) is sent to the terminal device 100 from the first SP server 200. The terminal device 100 displays the screen data received from the first SP server 200 on the display unit 114 by using its webview function. The subscription to the subscription service is completed as above. That is, the user can subscribe to the subscription service by using the subscription service function via the terminal device 100.

In case of the target service being the remote print service, the subscription process is executed between the target printer, the terminal device 100, and the second SP server 300. This subscription process includes a second establishment process, a second device registration process, etc. The second establishment process and the second device registration process are the same as the first establishment process and the first device registration process except that the target printer communicates with the second SP server 300. The subscription to the remote print service is completed as above. That is, the user can subscribe to the remote print service by using the remote print service function via the terminal device 100.

When the subscription process is completed in S74, the app 142 terminates the process of FIG. 5. At the end of the subscription process, the app 142 changes the first or second subscription information to “Subscribed” in the device table 144.

After making the determination YES in S72, the app 142 displays a firmware notification screen SC16 over the service screen SC14 in S80. The firmware notification screen SC16 includes a message for prompting the user to upgrade the version of the firmware in the target printer, an upgrade button 650, and a cancel button 652.

In S82, the app 142 receives an operation on the firmware notification screen SC16. In response to receiving an operation on the upgrade button 650, the app 142 first sends an upgrade instruction to the target printer and then terminates the display of the firmware notification screen SC16 and returns to S62. In response to receiving the upgrade instruction from the terminal device 100, the target printer executes a process to upgrade the version of the firmware. In contrast, in response to receiving an operation on the cancel button 652, the app 142 terminates the display of the firmware notification screen SC16 without sending the upgrade instruction, and then returns to S62.

After making the determination YES in S60, the app 142 displays a function setting screen on the display unit 114 in S90. A function setting screen SC18 shown in FIG. 5 is displayed in case of the target service being the subscription service. The function setting screen SC18 includes setting information 660, a setting button 662, and a cancel button 664. The setting information 660 includes settings related to the subscription service (e.g., the contractual number of sheets, the number of printed sheets, remaining amount of ink, contract plan, payment method, etc.). The setting button 662 is for changing a setting related to the subscription service. In case of the target service being the remote print service, the setting information in the function setting screen includes settings related to the remote print service.

In S92, the app 142 receives a setting operation for changing a setting related to the target service.

In S94, the app 142 executes a setting process. The setting process is for changing a setting corresponding to the setting operation received in S92. In case of the target service being the subscription service, the setting process is executed between the terminal device 100 and the first SP server 200. In case of the target service being the remote print service, the setting process is executed between the terminal device 100 and the second SP server 300. When S94 is completed, the app 142 terminates the process of FIG. 5. As above, the user can change a setting related to the target service via the terminal device 100. That is, the user can change a setting of the target service by using the target service function via the terminal device 100.

### Advantageous Effects of Embodiment

As described, the terminal device 100 displays the first app notification screen SC10 (see FIG. 6) (S40) in the case where the subscription button in the home screen is selected and it is determined that the version of the app 142 is not the minimum version Vmin corresponding to the subscription service function or newer (NO in S24 of FIG. 4). Thus, the terminal device 100 can display the first app notification screen SC10 at an appropriate time. This improves user convenience.

The terminal device 100 displays the first app notification screen SC12 (see FIG. 7) (S40) corresponding to the remote print service in the case where the remote print button in the home screen is selected and it is determined that the version of the app 142 is not the minimum version Vmin corresponding to the remote print service function or newer (NO in S24 of FIG. 4). Thus, the terminal device 100 can display the first app notification screen at an appropriate time according to the service function selected by the user. This improves user convenience.

### (Correspondence Relationships)

The app 142 is an example of “a computer program for a terminal device”. The printers 10A, 10B are examples of “target device”. The subscription service is an example of “first service”. The subscription service function is an example of “first function”. The operation of selecting the subscription button 620 in the home screen SC6 shown in FIG. 3 is an example of “first operation”. In case of the target service being the subscription service, the minimum version Vmin used in S24 of FIG. 4 is an example of “first version”. The first app notification screen SC10 shown in FIG. 6 is an example of “first notification screen”. The remote print service is an example of “second service”. The remote print service function is an example of “second function”. The operation of selecting the remote print button 622 in the home screen SC6 shown in FIG. 3 is an example of “second operation”. In case of the target service being the remote print service, the minimum version Vmin used in S24 of FIG. 4 is an example of “second version”. The first app notification screen SC12 shown in FIG. 7 is an example of “second notification screen”. The version information request in S18 of FIG. 4 is an example of “information request”. The model names are examples of “identification information”. The country information is an example of “area information”. The minimum version Vmin used in S14 of FIG. 4 is an example of “third version”. The firmware notification screen SC16 shown in FIG. 5 is an example of “third notification screen”. The cartridge is an example of “consumable article”.

S24 in FIG. 4 is an example of “determine whether a version of the computer program is a first version or newer”. S40 in FIG. 4 is an example of “display on a display of the terminal device a first notification screen”. S30 following the determination NO in S42 of FIG. 4 is an example of “restrict the user from using the first function via the terminal device”.

### Second Embodiment

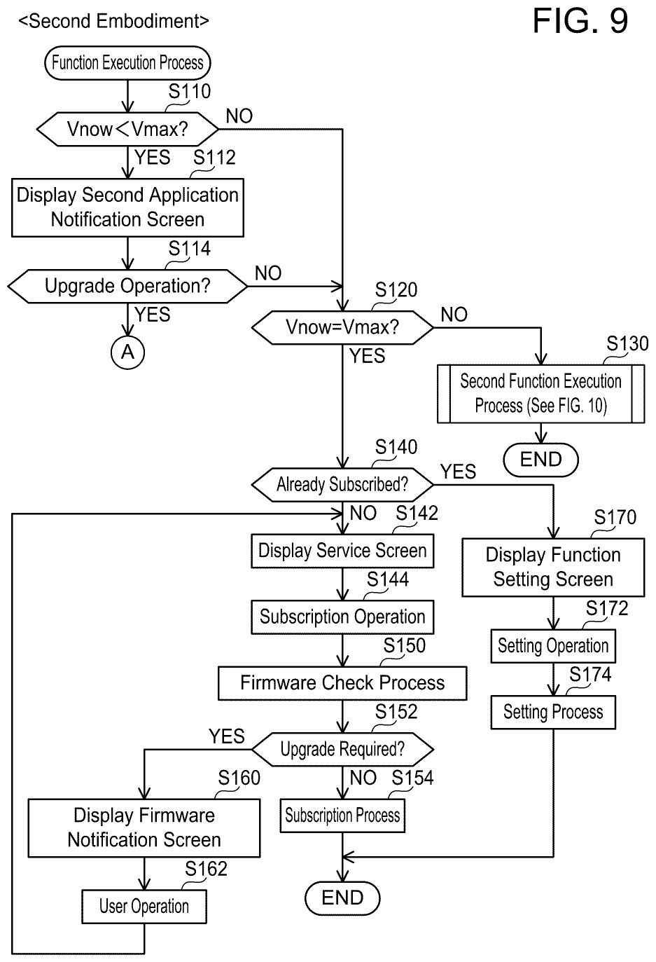

A communication system 2 according to a second embodiment is described. As shown in FIG. 2, in the second embodiment, the management table 440 in the management server 400 includes maximum version information, in addition to the app IDs, function names, model names, country information, and minimum version information. Each maximum version information indicates the maximum version required to use a service function and a version of the SP server corresponding to the service function. In S20 of FIG. 4, the app 142 receives version information including minimum version information and maximum version information from the management server 400 in response to having sent a version information request to the management server 400. In S26 of FIG. 4, the app 142 executes a function execution process shown in FIG. 9 instead of the function execution process shown in FIG. 5.

### (Function Execution Process: FIG. 9)

Referring to FIG. 9, the function execution process executed in S26 of FIG. 4 is described.

In S110, the app 142 determines whether the current version Vnow is older than a maximum version Vmax indicated by the maximum version information included in the received version information. When determining that the current version Vnow is older than the maximum version Vmax (YES in S110), the app 142 proceeds to S112, whereas when determining that the current version Vnow is not older than the maximum version Vmax (NO in S110), the app 142 proceeds to S120.

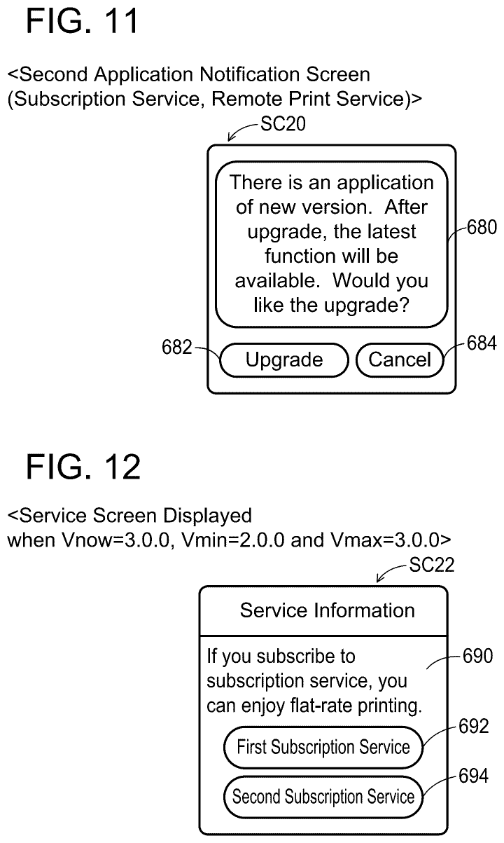

In S112, the app 142 displays a second app notification screen on the display unit 114. As shown in FIG. 11, a second app notification screen SC20 includes a message 680, an upgrade button 682, and a cancel button 684. The message 680 comprises a message indicating that an app of a newer version than the current version Vnow is available, a message indicating that the newest function is made available by using the app of newer version, and a message that inquires whether to upgrade the version of the app 142. The content of the second app notification screen SC20 does not differ between the target service being the subscription service and the target service being the remote print service. In case of the target service being the subscription service, the newest function is for example a function associated with the automatic ordering service. The configuration above allows the user to know that the app 142 of the maximum version Vmax is available. This improves user convenience.

In S114 of FIG. 9, the app 142 determines whether an upgrade operation of selecting the upgrade button in the second app notification screen has been received. When determining that the upgrade operation has been received (YES in S114), the app 142 proceeds to S44 of FIG. 4, whereas when determining that the upgrade operation has not been received (NO in S114), the app 142 proceeds to S120.

In S120, the app 142 determines whether the current version Vnow is the maximum version Vmax. When determining that the current version Vnow is the maximum version Vmax (YES in S120), the app 142 proceeds to S140, whereas when determining that the current version Vnow is not the maximum version Vmax (NO in S120), the app proceeds to S130.

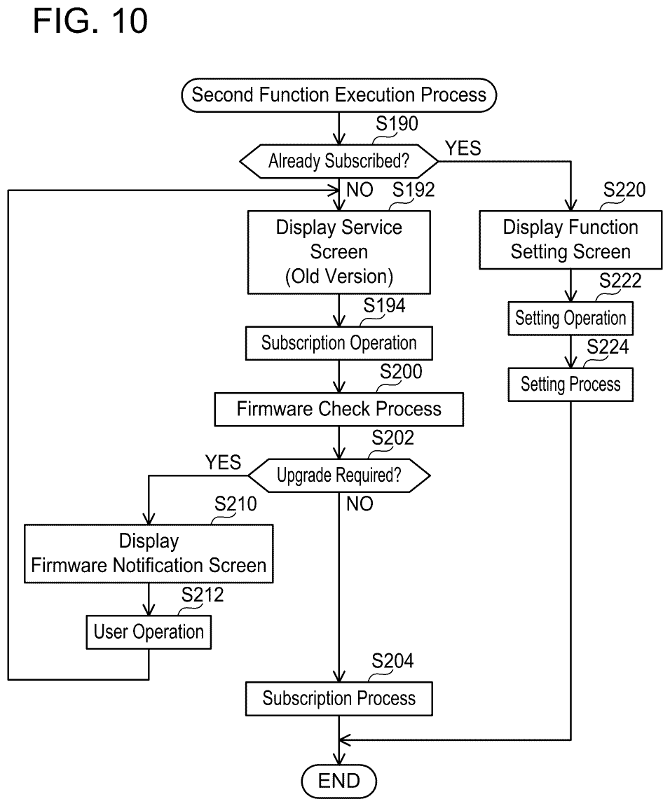

In S130, the app 142 executes a second function execution process (see FIG. 10). The second function execution process is for using the target service function via the terminal device 100. When S130 is completed, the app 142 terminates the process of FIG. 9.

A sequence from S140 to S174 is the same as the sequence from S60 to S94 in FIG. 5. In S142, the app 142 displays a service screen corresponding to the current version Vnow (i.e., the maximum version Vmax) on the display unit 114. Referring to FIG. 12, a service screen SC22 displayed in S142 is described. The service screen SC22 is an exemplary screen displayed when the current version Vnow, the minimum version Vmin, and the maximum version Vmax are “3.0.0”, “2.0.0”, and “3.0.0”, respectively. In this embodiment, the first SP server 200 can provide the flat-rate service and the automatic ordering service when its version is “3.0.0”, while the first SP server 200 can provide only the flat-rate service when its version is older than the version “3.0.0”. The app 142 first sends a screen data request corresponding to the current version Vnow “3.0.0” to the first SP server 200, receives service screen data from the first SP server 200, and then displays the service screen SC22 represented by the received service screen data on the display unit 114. The service screen SC22 includes a message 690, a first subscription service button 692, and a second subscription service button 694. The message 690 is the same as the message 640 shown in FIG. 8. The first subscription service button 692 is for subscribing to the subscription service including only the flat-rate service. The second subscription service button 694 is for subscribing to the subscription service including the flat-rate service and the automatic ordering service.

### (Second Function Execution Process: FIG. 10)

Referring to FIG. 10, the second function execution process executed in S130 of FIG. 9 is described.

S190 is the same as S60 in FIG. 5.

In S192, the app 142 displays a service screen on the display unit 114.

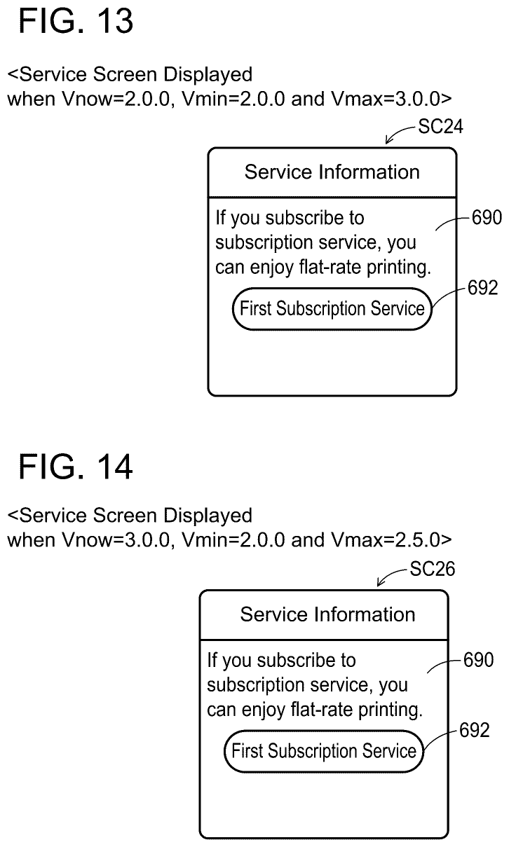

Referring to FIGS. 13 and 14, the service screen displayed in S192 is described.

Referring first to FIG. 13, a service screen SC24 displayed in S192 following YES in S110, NO in S114, and NO in S120 is described. The sequence of determinations YES in S110, NO in S114, and NO in S120 means that the current version Vnow is older than the maximum version Vmax. Specifically, the version of the app 142 has not been upgraded to the maximum version of the SP server corresponding to the target service. The service screen SC24 shown in FIG. 13 is displayed when the current version Vnow, the minimum version Vmin, and the maximum version Vmax are “2.0.0”, “2.0.0”, and “3.0.0”, respectively. The app 142 first sends a screen data request corresponding to the current version Vnow “2.0.0” to the first SP server 200. In response, the first SP server 200 sends service screen data corresponding to the minimum version Vmin “2.0.0” to the terminal device 100 even though it can send service screen data corresponding to the maximum version Vmax “3.0.0”. The app 142 then displays the service screen SC24 represented by the service screen data received from the first SP server 200 on the display unit 114. The service screen SC24 includes the message 690 and the first subscription service button 692. That is, the service screen SC24 does not include the second subscription service button 694 (see FIG. 12). Thus, the use of the automatic ordering service is restricted by the first SP server 200.

Referring now to FIG. 14, a service screen SC26 displayed in S192 in FIG. 10 following NO in S110 and NO in S120 in FIG. 9 is described. The sequence of determinations NO in S110 and NO in S120 means that the current version Vnow is older than the maximum version Vmax. Specifically, the version of the SP server corresponding to the target service has not been upgraded to the current version Vnow. The service screen SC26 shown in FIG. 14 is displayed when the current version Vnow, the minimum version Vmin, and the maximum version Vmax are “3.0.0”, “2.0.0”, and “2.5.0”, respectively. The app 142 first sends a screen data request corresponding to the maximum version Vmax “2.5.0” which is older than the current version Vnow “3.0.0” to the first SP server 200 even though it can send a screen data request corresponding to the current version Vnow “3.0.0”. In response, the first SP server 200 sends service screen data corresponding to the maximum version Vmax “2.5.0” to the terminal device 100. The app 142 then displays the service screen SC26 represented by the service screen data received from the first SP server 200 on the display unit 114. The service screen SC26 is the same as the service screen SC24 shown in FIG. 13. That is, the service screen SC26 does not include the second subscription service button 694 (see FIG. 12). Thus, the use of the automatic ordering service is restricted by the app 142.

A sequence from S194 to S224 is the same as the sequence from S64 to S94 in FIG.

### (Correspondence Relationship)

The second app notification screen SC20 shown in FIG. 11 is an example of “fourth notification screen”.
(Modification 1) In the above embodiments, the servers 200, 300, 400 and 500 are all physical servers, however, the servers 200, 300, 400, and 500 are not limited to physical servers and may be virtual servers or virtual machines on the cloud. That is, the vendor need not to prepare hardware for the servers 200, 300, 400, and 500 and may use an environment provided by an external cloud computing service. In this case, the vendor may prepare a program (software) for each of the servers 200, 300, 400, and 500 and introduce the programs into the above environment to implement the servers 200, 300, 400, and 500. In another modification, the servers 200, 300, 400, and 500 may be established on the internet 6 by business operator(s) different from the vendor.
(Modification 2) The app 142 in the terminal device 100 executes the first check process of FIG. 4 in response to receiving the subscription operation on the service screen or the setting operation on the function setting screen. In this modification, in the case where the service button in the home screen is selected, the app 142 uses the device table 144 to determine whether the user of the target printer has already subscribed to the target service. The app 142 then displays the service screen on the display unit 114 in the case where the user has not subscribed to the target service yet, whereas the app 142 displays the function setting screen on the display unit 114 in the case where the user has already subscribed to the target service. Then, the app 142 executes the first check process in response to receiving the subscription operation on the service screen or the setting operation on the function setting screen. In this modification, S62, S64, S90, and S92 of the function execution process according to the first embodiment shown in FIG. 5 are omitted. Further, S142, S144, S170, and S172 in FIGS. 9 and S192, S194, S220, and S222 in FIG. 10 of the function execution process according to the second embodiment are omitted.
(Modification 3) In case of the determination NO in S42 of FIG. 4, the app 142 in the terminal device 100 may display on the display unit 114 an error notification screen indicating that the target service function is not available to restrict the user from using the target service function via the target terminal 100.
(Modification 4) The communication system 2 may comprise only one of the first SP server 200 and the second SP server 300. In this modification, the user can use only one of the subscription service function and the remote print service function via the terminal device 100. In this modification, “determine whether the version of the computer program is a second version or newer”, “display on the display a second notification screen”, and “restrict the user from using the second function via the terminal device” may be omitted.
(Modification 5) The app 142 in the terminal device 100 may display on the display unit 114 a screen that prompts the user to subscribe to the subscription service (or the remote print service) in a pop-up manner. In this modification, the app 142 executes the first check process of FIG. 4 in response to receiving an operation on this screen.
(Modification 6) The app 142 in the terminal device 100 may send a version information request to the management server 400 at a regular interval of predetermined time period. In this modification, the app 142 uses version information received from the management server 400 at the regular interval of predetermined time period to execute S24 of the first check process shown in FIG. 4. In this modification, S16 to S20 may be omitted. In this modification, “send an information request” and “receive version information” may be omitted. In another modification, the user of the terminal device 100 may input minimum version information to the terminal device 100.
(Modification 7) The management table 440 in the management server 400 may include one or more of an app ID, a function name, a model name, and country information. The management table 440 may include OS information related to an OS type. For example, the OS information indicates Android (registered trademark) or iOS.
(Modification 8) “Identification information” is not limited to a model name and may be a serial number or a MAC address of a printer.
(Modification 9) “Area information” is not limited to country information, and may be information indicating a larger area than the area indicated by country information or information indicating a smaller area (city, etc.) than the area indicated by country information.
(Modification 10) The version information request sent in S18 of FIG. 4 may include one or more of an app ID, a function name, a model name, and country information. For example, in case of the version information request including only country information, the management server 400 sends the terminal device 100 version information including the app ID, function name, model name, and minimum version information associated with the country information included in the request. The app 142 in the terminal device 100 then specifies, from the version information received from the management server 400, the app ID “AP1” of the app 142, the function name corresponding to the target service function, and minimum version information associated with the model name of the target printer
(Modification 11) S16 in FIG. 4 may be omitted. In this modification, “determine whether the terminal device and the management server are communicable with each other” may be omitted.
(Modification 12) S12, S14, and S22 in FIG. 4 may be omitted. In this modification, “determine whether the version of the computer program is the third version stored in the memory or newer” and “store the first version indicated by the version information in the memory” may be omitted.
(Modification 13) In the first embodiment, S70, S72, S80, and S82 may be omitted. In the second embodiment, S150, S152, S160, and S162 in FIGS. 9 and S200, S202, S210, and S212 in FIG. 10 may be omitted. In this modification, “determine whether firmware installed in the target device is required to be upgraded” and “display on the display a third notification screen” may be omitted. In another modification, S70, S72, S80, and S82 in FIG. 5 may be executed before S10 in FIG. 4 in the first embodiment. The same applies to S150, S152, S160, and S162 in FIGS. 9 and S200, S202, S210, and S212 in FIG. 10 in the second embodiment.
(Modification 14) “First function” may be the remote print service function, a consumable article purchasing service function corresponding to a consumable article purchasing service, a remote scan service function corresponding to a remote scan service, or the like. “Second function” may be the subscription service function, the consumable article purchasing service function, the remote scan service function, or the like.
(Modification 15) In the embodiments above, the processes in FIGS. 3 to 14 are implemented by software (e.g., the programs 140, 142), however, at least one of these processes may be implemented by hardware such as a logic circuit.

What is claimed is:

1. A non-transitory computer-readable recording medium storing a computer program for a terminal device comprising a processor, wherein the computer program, when executed by the processor, cause the terminal device to:
in a case where a first operation for using a first function is received, determine whether a version of the computer program is a first version or newer, wherein the first function is realized by cooperation between a target device different from the terminal device and a first service providing server that provides a first service related to the target device;
in a case where it is determined that the version of the computer program is not the first version or newer, display on a display of the terminal device a first notification screen for prompting a user to upgrade the computer program; and
in a case where an operation to upgrade the computer program is not received in the first notification screen, restrict the user from using the first function via the terminal device.

2. The non-transitory computer-readable recording medium according to claim 1, wherein the target device includes a printer, and
wherein the first service includes a service for providing consumable article of the target device to user.

3. The non-transitory computer-readable recording medium according to claim 1, wherein the target device is a printer, and
wherein the first service includes a service for automatically ordering consumable article of the target device.

4. The non-transitory computer-readable recording medium according to claim 1, wherein the computer program, when executed by the processor, further cause the terminal device to:
in a case where a second operation for using a second function is received, determine whether the version of the computer program is a second version or newer, wherein the second function is realized by cooperation between the target device and a second service providing server that provides a second service related to the target device;
in a case where it is determined that the version of the computer program is not the second version or newer, display on the display a second notification screen for prompting the user to upgrade the computer program; and
in a case where an operation to upgrade the computer program is not received in the second notification screen, restrict the user from using the second function via the terminal device.

5. The non-transitory computer-readable recording medium according to claim 4, wherein the target device includes a printer, and
wherein the second service includes a remote print service.

6. The non-transitory computer-readable recording medium according to claim 1, wherein the first operation is for subscribing to the first service.

7. The non-transitory computer-readable recording medium according to claim 1, wherein the first operation is for changing a setting related to the first service.

8. The non-transitory computer-readable recording medium according to claim 1, wherein the computer program, when executed by the processor, further cause the terminal device to:
in the case where the first operation is received, send an information request to a management server; and
in response to sending the information request to the management server, receive version information from the management server, wherein the version information indicates the first version that is a version of the computer program required to use the first function, and
wherein it is determined whether the version of the computer program is the first version indicated by the version information or newer.

9. The non-transitory computer-readable recording medium according to claim 5, wherein the management server is configured to store, for each of a plurality of devices, identification information for identifying the device and a version of the computer program required to use the first function in association with each other,
the information request includes target identification information for identifying the target device, and
the version information indicates the first version stored in the management server in association with the target identification information.

10. The non-transitory computer-readable recording medium according to claim 5, wherein the management server is configured to store each of area information and a version of the computer program required to use the first function in association with each other,
the information request includes target area information indicating an area in which the target device is installed, and
the version information indicates the first version stored in the management server in association with the target area information.

11. The non-transitory computer-readable recording medium according to claim 5, wherein the computer program, when executed by the processor, further cause the terminal device to:
in the case where the first operation is received, determine whether the terminal device and the management server are communicable with each other,
wherein in a case where it is determined that the terminal device and the management server are not communicable with each other, use of the first function by the user via the terminal device is restricted regardless of whether the version of the computer program is the first version.

12. The non-transitory computer-readable recording medium according to claim 5, wherein the terminal device further comprises a memory configured to store a version of the computer program required to use the first function,
wherein the computer program, when executed by the processor, further cause the terminal device to:
in a case where the first operation is received and a third version is stored in the memory as a version of the computer program required to use the first function, determine whether the version of the computer program is the third version stored in the memory or newer,
wherein in a case where it is determined that the version of the computer program is the third version or newer, the information request is sent to the management server,
in a case where it is determined that the version of the computer program is not the third version or newer, the information request is not sent, and
in the case where it is determined that the version of the computer program is not the third version or newer, the first notification screen is displayed on the display,
wherein the computer program, when executed by the processor, further cause the terminal device to:
in a case where the version information is received from the management server, store the first version indicated by the version information in the memory as a version of the computer program required to use the first function, instead of the third version.

13. The non-transitory computer-readable recording medium according to claim 1, wherein the computer program, when executed by the processor, further cause the terminal device to:
in the case where it is determined that the version of the computer program is the first version or newer, determine whether firmware installed in the target device is required to be upgraded; and
in a case where it is determined that the firmware is required to be upgraded, display on the display a third notification screen for prompting the user to upgrade the firmware.

14. The non-transitory computer-readable recording medium according to claim 1, wherein the computer program, when executed by the processor, further cause the terminal device to:
in the case where the first operation is received, determine whether the version of the computer program is older than a maximum version that allows for use of the first function; and
in a case where it is determined that the version of the computer program is the first version or newer and older than the maximum version, display on the display a fourth notification screen for prompting the user to upgrade the computer program to the maximum version.

15. The non-transitory computer-readable recording medium according to claim 1, wherein the first version is a minimum version of the computer program required to use the first function.

16. A terminal device comprising:
a display; and
a controller configured to:
in a case where a first operation is received, determine whether a version of a computer program is a first version or newer, wherein the first operation is for using a first function realized by cooperation between a target device different from the terminal device and a first service providing server that provides a first service related to the target device;
in a case where it is determined that the version of the computer program is not the first version or newer, display on the display a first notification screen for prompting a user to upgrade the computer program; and
in a case where an operation to upgrade the computer program is not received in the first notification screen, restrict the user from using the first function via the terminal device.

17. A method for controlling a terminal device, the method comprising:
in a case where a first operation is received, determining whether a version of a computer program is a first version or newer, wherein the first operation is for using a first function realized by cooperation between a target device different from the terminal device and a first service providing server that provides a first service related to the target device;
in a case where it is determined that the version of the computer program is not the first version or newer, displaying on a display of the terminal device a first notification screen for prompting a user to upgrade the computer program; and
in a case where an operation to upgrade the computer program is not received in the first notification screen, restricting the user from using the first function via the terminal device.

18. The method according to claim 17, wherein the target device includes a printer, and
wherein the first service includes a service for providing consumable article of the target device to user.

19. The method according to claim 17, wherein the target device is a printer, and
wherein the first service includes a service for automatically ordering consumable article of the target device.

20. The method according to claim 17, further comprising:
in a case where a second operation for using a second function is received, determining whether the version of the computer program is a second version or newer, wherein the second function is realized by cooperation between the target device and a second service providing server that provides a second service related to the target device;
in a case where it is determined that the version of the computer program is not the second version or newer, displaying on the display a second notification screen for prompting the user to upgrade the computer program; and
in a case where an operation to upgrade the computer program is not received in the second notification screen, restricting the user from using the second function via the terminal device.
